(19) United States
(12) Patent Application Publication
(10) Pub. No.: US 2014/0030013 A1
(43) Pub. Date: Jan. 30, 2014

(54) FIXING MECHANISM

(71) Applicants: Fu Tai Hua Industry (Shenzhen) Co., Ltd., (US); HONG HAI PRECISION INDUSTRY CO., LTD., New Taipei (TW)

(72) Inventor: JU-LAN HAO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/727,444

(22) Filed: Dec. 26, 2012

(30) Foreign Application Priority Data
Jul. 27, 2012 (CN) 2012102629362

(51) Int. Cl. F16B 17/00

(52) U.S. Cl. CPC F16B 17/00
USPC 403/327

(57) ABSTRACT

A fixing mechanism includes a base with a receiving recess for receiving an electronic device, several groups of springs and balls. On the sidewall of the receiving recess several groups of receiving holes are defined, each receiving hole receives a spring and a metallic ball and the each ball is part out of the each receiving hole. One end of the each spring is connected to the bottom of the each receiving hole, the other is connected to the each ball. When an electronic device is put in the receiving recess, the sidewall of the electronic device support the balls and push the springs to make them compressed, thereby, the springs give a force to the electronic device through the balls and fix the electronic device in the receiving recess firmly.

### BACKGROUND

1. Technical Field

Embodiments of the present disclosure relate to fixing mechanisms, particularly, to a fixing mechanism for fixing a portable electronic device during assembly.

2. Description of related art

Portable consumer electronic devices are becoming evermore powerful and complex. Such complexity brings many challenges, such as how to test various internal components in space of limited size reliably and conveniently without undue expense. Currently, on assembly lines devices may be fixed in place by a worker using clamps and or screws so that they may perform tests on the devices without the device moving freely. Performing such tasks is difficult and time consuming. Therefore, a new fixing mechanism for quickly and easily fixing a electronic devices in place while they undergo testing is needed.

### BRIEF DESCRIPTION OF THE DRAWINGS

FIG. 1 is a exploded view of one embodiment of a fixing mechanism.

FIG. 2 is a assembled view showing an electronic device in the fixing mechanism of FIG. 1.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

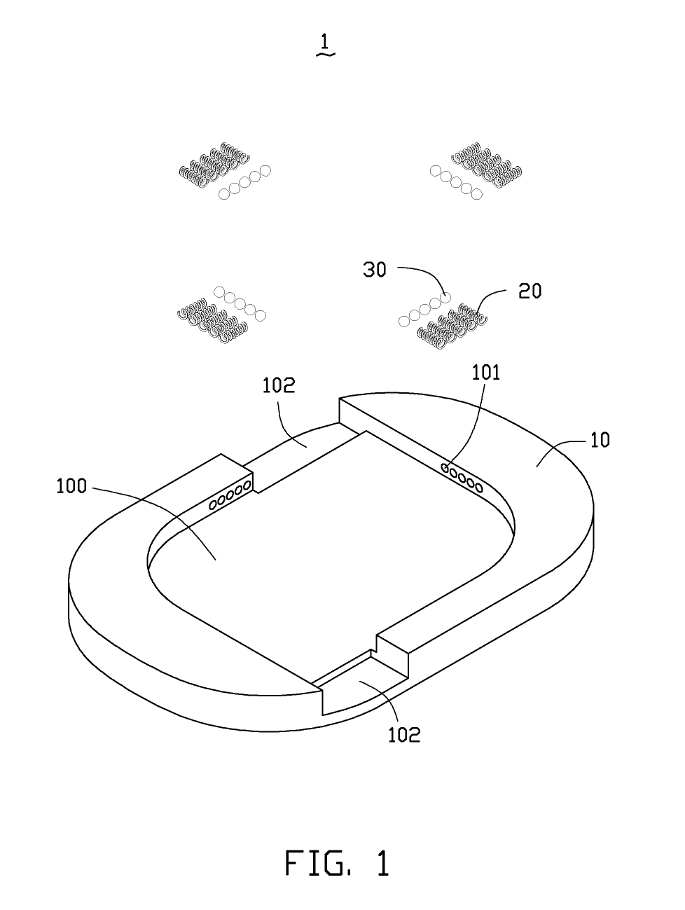

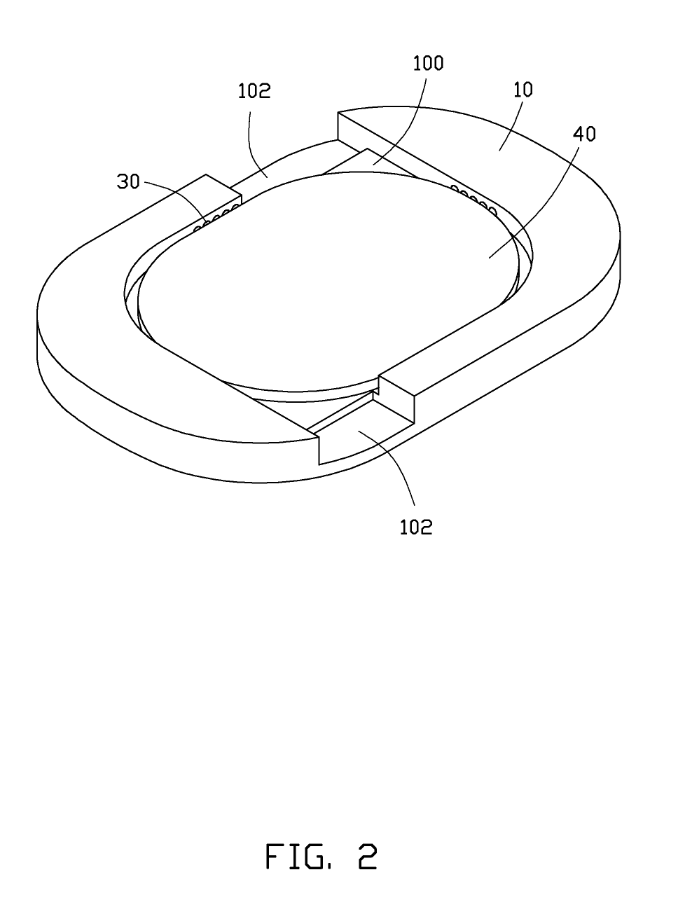

FIG. 1 is an exploded view of one embodiment of a fixing mechanism 1 which includes a base 10, four groups of springs 20, and four groups of balls 30. In the embodiment, each group includes five springs 20 and five metallic balls 30. The base 10 defines a receiving recess 100 for receiving an electronic device 40 (FIG. 2). Four groups of receiving holes 101 (two of them not shown) are defined on the sidewall of the receiving recess 100, and each group includes five receiving holes 101.

Each receiving hole 101 receives a spring 201 and a ball 301. One end of the spring 201 is connected to the bottom of the receiving hole 101, and the other end is connected to the ball 301. A portion of the ball 301 protrudes out of the receiving hole 101. In the embodiment, two openings 102 communicated with the receiving recess 100 are defined in the top of the base 10 for ease of putting the electronic device 40 into the receiving recess 100.

FIG. 2 is an assembled view showing the electronic device 40 in the fixing mechanism 1. When the electronic device 40 is put in the receiving recess 100, the sidewalls of the electronic device 40 abut against the balls 301. The springs 201 are compressed and apply a pushing force to the electronic device 40 through the balls 301, thereby firmly fixing the electronic device 40 in the receiving recess 100.

In the embodiment, the balls 301 are made of metal, in other embodiments, the balls 301 may be made of other material such as plastic or rubber. The fixing mechanism 1 is quick and easy to use. Workers can quickly fix a device in place while they test or install various components of the device, then remove the device and replace it with another in a timely manner, which cuts down on the expense of assembly.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A fixing mechanism comprising:
a base defining a receiving recess for receiving an electronic device, on a sidewall of the receiving recess a plurality of receiving holes being defined;
a plurality of springs received in the plurality of receiving holes, a first end of each of the springs being connected to a bottom of each of the receiving holes; and
a plurality of balls, each of which is partly received in a corresponding one of the plurality of receiving holes and is connected to a second end of the corresponding spring.

2. The fixing mechanism as described in claim 1, wherein two openings communicated to the receiving recess are defined in the top of the of the base.

3. The fixing mechanism as described in claim 1, wherein four groups of receiving holes are set on the sidewall of the receiving recess.

4. The fixing mechanism as described in claim 1, wherein the balls are made of material selected from a group consisting of metal, plastic, and rubber.
